(19) United States
(12) Patent Application Publication
(10) Pub. No.: US 2024/0243921 A1
(43) Pub. Date: Jul. 18, 2024

(54) Side-Channel Protection in Hash-Based Signatures

(71) Applicant: Infineon Technologies AG, Neubiberg (DE)

(72) Inventors: Martin Schläffer, Zell am See (AT); Martin Steinbach, Augsburg (DE)

(21) Appl. No.: 18/409,142

(22) Filed: Jan. 10, 2024

(30) Foreign Application Priority Data
Jan. 18, 2023 (DE) 102023101138.3

(51) Int. Cl. H04L 9/32; H04L 9/30

(52) U.S. Cl. CPC H04L 9/3247; H04L 9/30

(57) ABSTRACT

An approach for generating a Hash-based signature based on a Winternitz one-time signature scheme, wherein the signature comprises several signature values (SIG[N1], . . . , SIG[N32]), which are determined via Hash-functions that are iteratively applied depending on a message and/or checksum, comprising the step: the signature values are generated at least partially in a mixed order, which is determined based on at least one of the following: (i) a predefined or deterministic pattern, (ii) a pseudo-random pattern, or (iii) a random pattern.

### TECHNICAL FIELD

The present disclosure is generally related to cryptography, and is more particularly related to hash-based cryptographic systems.

### BACKGROUND

Hash-based cryptography is the generic term for constructions of cryptographic primitives based on the security of hash functions. This is in particular relevant with respect to post-quantum cryptography.

So far, hash-based cryptography is used to construct digital signature schemes such as the Merkle signature scheme, zero knowledge and computationally integrity proofs.

Hash-based signature schemes combine a one-time signature scheme, such as a Lamport signature, with a Merkle tree structure. Since a one-time signature scheme key can only sign a single message securely, it is practical to combine many such keys within a single, larger structure. This is achieved by the so-called Merkle tree structure, which is a hierarchical data structure, in which a hash function and concatenation are used repeatedly to compute tree nodes.

One consideration with hash-based signature schemes is that they can only sign a limited number of messages securely, because of their use of one-time signature schemes. The US National Institute of Standards and Technology (NIST), specified that algorithms in its post-quantum cryptography competition support a minimum of 2⁶⁴ signatures safely.

In 2022, NIST announced SPHINCS+ as one of three algorithms to be standardized for digital signatures. NIST standardized stateful hash-based cryptography based on the extended Merkle Signature Scheme (XMSS) and Leighton-Micali Signatures (LMS), which are applicable in different circumstances.

Request for Comments (RFC) 8391 refers to the extended Merkle Signature Scheme (XMSS) and RFC 8554 describes Leighton-Micali Hash-Based Signatures in more detail. An introduction to Hash-Based Signatures is provided in [https://blog.cryptographyengineering.com/2018/04/07/hash-based-signatures-an-illustrated-primer/].

RFC 8391 defines in section 2.5 a Hash Function Address Scheme to generate secret keys from a key SEED. Further, starting in section 3, RFC 8391 refers to the WOTS+ scheme (WOTS: Winternitz One-Time Signatures). A private key can only be used once to sign a message (hence the name “One-Time” Signature). If the private key is used to sign two (or more) different messages, the scheme becomes insecure. In order to use a different key for each Hash function, the key SEED and a 32-byte address ADRS are used as inputs to a pseudorandom function PRF. A WOTS chain is generated by computing an iteration of the Hash function on an n-byte input using outputs of the pseudorandom function PRF.

FIG. 1 illustrates an example of the WOTS scheme. As a Hash function, SHA-256 may be used (see also, e.g., https://medium.com/asecuritysite-when-bob-met-alice/w-otss-the-problem-sleepwalking-into-a-broken-world-of-trust-7a6e027did9f).
Step 101: 32 256-bit random numbers Priv[0] to Priv[31] are generated (for example, based on a secret SEED). These 32 values can be regarded as the (one-time) secret key.
Step 102: Each of the 32 values is bashed 256 times using SHA-256 as an exemplary Hash function. This results in 32 256-bit values Pub[0] to Pub[31], which are regarded as public key. One characteristic of the Hash function is that it is not possible to calculate Priv[i] based on merely Pub[i] (with i=0, . . . , 31).
Step 103: A message M is hashed (using SHA-256), which results in a 256-bit value, which is separated into 32 8-bit values N1, . . . , N32.
Step 104: A signature for the message M is generated as follows: Based on the first 8-bit value N1, the portion Priv[0] of the private key is hashed (by applying the Hash function SHA-256) 256-N1 times. This results in the first portion SIG[N1] of the signature.
   For example, if N1 equals 20, the value SIG[N1] is obtained by applying the Hash function 236 based on Priv[0], wherein the result of the previous Hash function is input to the next iteration of the Hash function.
   This approach is applied accordingly for the remaining values N2 to N32 using the respective values Priv[2] to Priv[32] resulting in the remaining values SIG[N2] to SIG[N32] of the signature.
   The signature hence comprises the values SIG[N1], . . . , SIG[N32].
Step 105: Verification of signature: The values N1 to N32 can be determined based on the message M (as described in step 103). Also, the signature SIG[1], . . . , SIG[32] is available.
   The value SIG[N1] is hashed N1 times. If the result equals the value Pub[0] of the public key, the portion SIG[N1] of the signature is verified.
   With regard to the example above (N1=20), the Hash function has been applied 236 times to reach SIG[N1]. It is now applied for another 20 times, which results to an overall of 256, reaching the value Pub[0] of the public key according to step 102.
   This approach is applied accordingly for the remaining values SIG[2] to SIG[32]. If all values Pub[1] to Pub[31] are verified, the signature of the message M is deemed valid.
   This approach is considered robust against attacks from quantum computers. However, as a downside, there is no protection against side-channel attacks.

Hence, the objective is to overcome this disadvantage and to further barden in particular solutions directed to post-quantum cryptography (PQC) against side-channel attacks.

### SUMMARY

The problems discussed above are addressed by the independent claims. Further embodiments result from the dependent claims.

The examples described herein may in particular be based on at least one of the following solutions. Combinations of the following features may be utilized to reach a desired result. The features of the method could be combined with any feature(s) of the device or vice versa.

A method is described for generating a Hash-based signature based on a Winternitz one-time signature scheme, wherein the signature comprises several signature values (SIG[N1], . . . , SIG[N32]), which are determined via Hash-functions that are iteratively applied depending on a message and/or checksum, comprising the step:
the signature values are generated at least partially in a mixed order, which is determined based on at least one of the following:
a predefined or deterministic pattern,
a pseudo-random pattern,
a random pattern.

It is noted that the generation of the signature values may involve (iteratively) applying Hash-functions in order to reach the actual signature value. Each signature values hence corresponds to a WOTS chain that is calculated (by applying the Hash-functions) up to the respective signature value. By mixing the order of generating the signature values (i.e., mixing calculating the WOTS chains), a side channel attack (without additional knowledge) is not able to determine which signature value (i.e., which WOTS chain) is currently processed. This improves existing approaches that follow a stringent calculation of WOTS chains in the order in which they are further processed.

It is further noted that such mixing the generation of the signature values may require that after the generation of several signature values, the order is restored such that the signature values can be further processed as a signature that can be used in combination with existing signature verification tools.

According to an embodiment, the mixed order is temporarily stored in order to restore the order of the signature values before they are further processed.

According to an embodiment, for at least one of the signature values the Hash function is conducted at least one more time than necessary according to the Winternitz one-time signature scheme.

According to an embodiment, for at least one signature value the Hash function is iterated as many times as necessary to reach the corresponding public key value.

According to an embodiment, for at least one of the signature values the Hash function is conducted an additional number ai times, wherein ai is larger than the number of times required to determine the signature value according to the Winternitz one-time signature scheme and smaller than or equal to the number of times necessary to reach the public key value, wherein ai is determined based on at least one of the following:
a deterministic scheme,
a predefined scheme,
a pseudo-random scheme,
a random scheme.

According to an embodiment, different numbers ai are used for different signature values.

According to an embodiment, the method further comprises:
for at least one of the signature values the Hash function is conducted at least one more time than required according to the Winternitz one-time signature scheme, wherein the signature value is based on the checksum.

According to an embodiment, a generator function that determines one-time keys based on a secret SEED, wherein such one-time keys are the basis for iteratively applying the Hash function, is protected from side-channel attacks.

According to an embodiment, the one-time keys are processed at least partially in a mixed order, which is determined based on at least one of the following:
a predefined or deterministic pattern,
a pseudo-random pattern,
a random pattern.

According to an embodiment, the Hash function is a cryptographically hardened Hash function.

Also, a device is suggested for generating a Hash-based signature based on a Winternitz one-time signature scheme, wherein the signature comprises several signature values (SIG[N1], . . . , SIG[N32]), which are determined via Hash-functions that are iteratively applied depending on a message and/or checksum, wherein the device is arranged to conduct the step:
the signature values are generated at least partially in a mixed order, which is determined based on at least one of the following:
a predefined or deterministic pattern,
a pseudo-random pattern,
a random pattern.

It is noted that the steps of the method stated herein may be executable on this device unit as well. The device may be or comprises a processing unit for conducting at least one of the steps described herein.

It is further noted that said device can comprise at least one, in particular several means that are arranged to execute the steps of the method described herein. The means may be logically or physically separated; in particular several logically separate means could be combined in at least one physical unit.

Said device may comprise at least one of the following: a processor, a microcontroller, a hard-wired circuit, an ASIC, an FPGA, a logic device.

According to an embodiment, the device is a cryptographic device or a device that is arranged to conduct at least one cryptographic function, in particular to generate the Hash-based signature.

According to an embodiment, said device is a security device comprising at least one of the following:
an integrated circuit,
a hardware security module,
a trusted platform module,
a crypto unit,
a FPGA,
a processing unit,
a controller,
a smartcard.

Further, a computer program product is suggested, which is directly loadable into a memory of a digital processing device, comprising software code portions for performing the steps of the method as described herein.

In addition, the problem stated above is solved by a computer-readable medium, e.g., storage of any kind, having computer-executable instructions adapted to cause a computer system to perform the method as described herein.

### BRIEF DESCRIPTION OF THE FIGURES

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a flow chart of the known WOTS scheme.

FIG. 2 shows an example for generating a Hash-based signature that is hardened against side-channel attacks.

FIG. 3 shows an alternative example for generating a Hash-based signature that is hardened against side-channel attacks.

### DETAILED DESCRIPTION

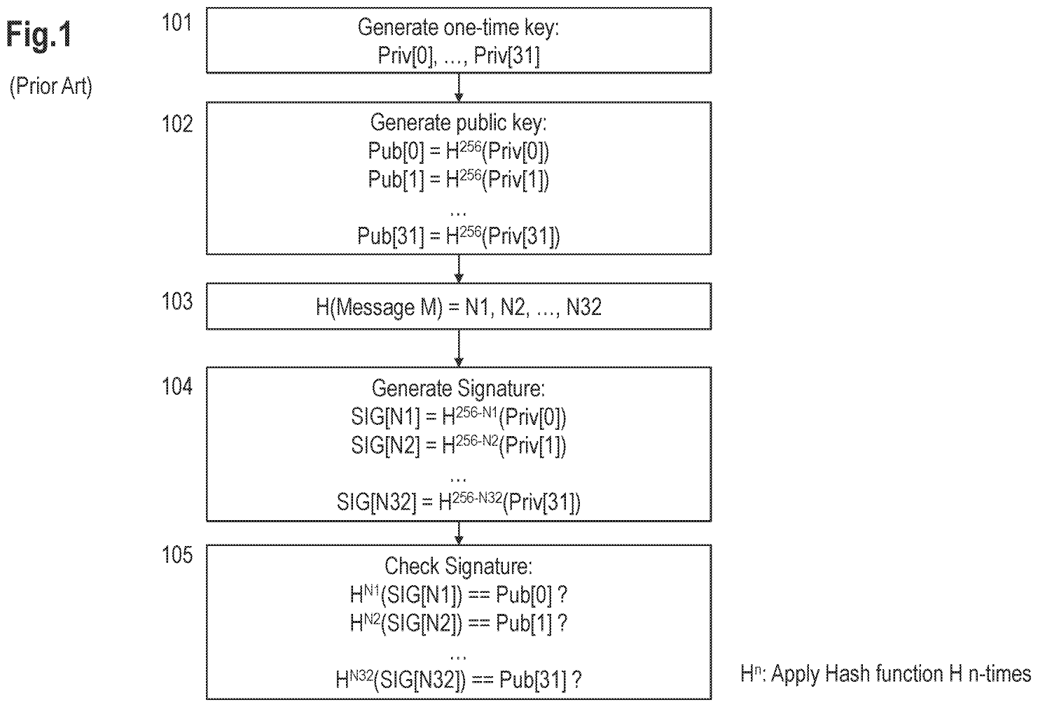

A WOTS chain is regarded as an operation that determines a value of a signature based on a private one-time key. This may involve a Hash function that is applied several times in order to reach the value of the signature. It is also an option that the value of the one-time key is identical to the value of the signature. In the example shown in FIG. 1, this applies for N1=256:

$${H}^{256 - N 1} ( Priv [ 0 ] ) = {H}^{0} ( Priv [ 0 ] ) = Priv [ 0 ] = SIG [ N 1 ] .$$

This can also be regarded as WOTS chain, because in order to check the validity, the verifier has to apply the Hash function N1=256 times reaching the value Pub[0] of the associated public key portion.

Applying the Hash function n-times means that the result of the previous Hash function is input to the next iteration of the Hash function.

As described above, the WOTS scheme requires a large amount of Hash computations. The examples suggested herein allow protecting Hash computations against side-channel attacks. Also, computations using the secret keys are protected against such attacks. In addition, the solutions described herein are a cost-efficient way to protect the Hash functions.

For example, using XMSS in combination with SHA-256 as an exemplary Hash function, results in a huge amount of calls of the key generator function, which without protection constitute a significant risk for successful side-channel attacks.

Examples described herein in particular refer to XMSS, but may be applicable to other scenarios accordingly.

As an example of generating values of the signature, it is suggested changing the calculation of the WOTS chain such that it does not need to stop as soon as the value used as a signature is reached. Instead, it is suggested conducting at least one additional Hash function towards the public key.

In the example above shown with regard to FIG. 1, N1 equals 20 and the Hash function is applied 236 times based on Priv[0].

According to an embodiment described herein, it is suggested to apply the Hash function for more than 236 times. It is in particular an option to apply additional 20 iterations to reach the value Pub[0] of the public key.

This could be applied to at least one WOTS chain or a portion of WOTS chains or all WOTS chains.

There are in particular the following variants that could be applied for at least one WOTS chain:
(1) Apply the Hash function more than 256-Ni times.
(2) Apply the Hash function as many times necessary to reach the value of the public key portion (e.g., a total of 256 times).

It is noted that according to variant (1), the additional number of times the Hash function is to be applied, could be determined in a fixed, pseudo-random or random manner: At least two different WOTS chains may be subject to different iterations ki and kj with

$$256 - Ni < ki \leq 256 ,$$

$$256 - Nj < kj \leq 256 ,$$

$$ki \neq kj .$$

Each of the indices i=1, . . . , 32 and j=1, . . . , 32 identifies one of the 8-bit values N1 to N32.

In this example, 256 is the number of times the Hash function has to be iteratively applied to transform the value of the private key into the value of the respective public key.

In a particular embodiment, a portion of the WOTS chains or all of the WOTS chains are calculated “until the end”, i.e. until the value of the public key portion is reached.

It is also an option to apply this solution only to a portion of WOTS chains, in particular not to all WOTS chains. The decision which WOTS chain(s) to be selected may be also subject to a predetermined, pseudo-random or random approach.

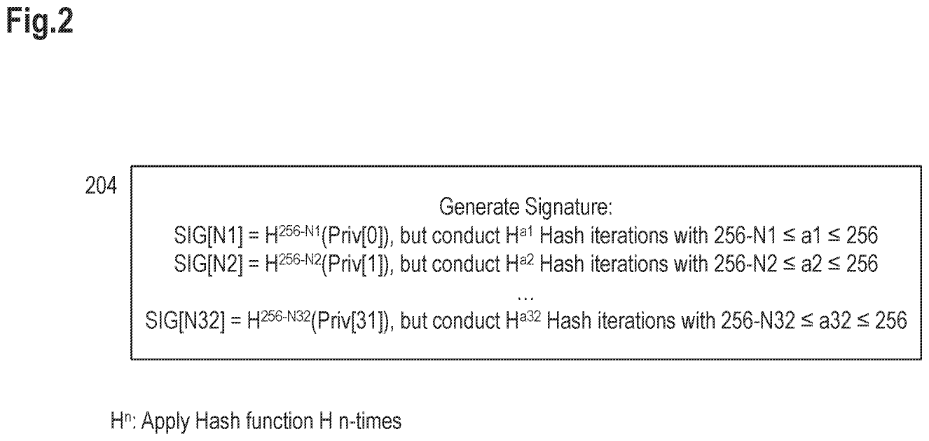

FIG. 2 shows an exemplary diagram comprising a step 204 which may substitute step 104 in FIG. 1. The values SIG[N1] to SIG[N32] of the signature are calculated as described before with regard to FIG. 1, but additional Hash operations are conducted: At least in one of the cases, at least one additional iteration H^{ai} of the Hash function is conducted, wherein 256-Ni≤ai≤256 with i=1, . . . , 32.

The solution presented efficiently protects WOTS chains against side-channel attacks.

### Optional: Changing the Sequence of Calculating WOTS Chains

It is also an option to calculate the WOTS chains in a mixed or different order: The order may be changed according to
a predefined pattern,
a pseudo-random pattern,
a random pattern.

Such changing can be applied to all WOTS chains or (only) a portion of the WOTS chains. Advantageously, the calculation of the WOTS chains may be conducted in a different order, but the results of the calculations may be provided in order such that further processing can be conducted without compatibility issue. In other words, an intermediate “mixing” may be conducted to reach the results of the WOTS chains, wherein the results can be made available to the next steps in their originally intended and pre-defined order.

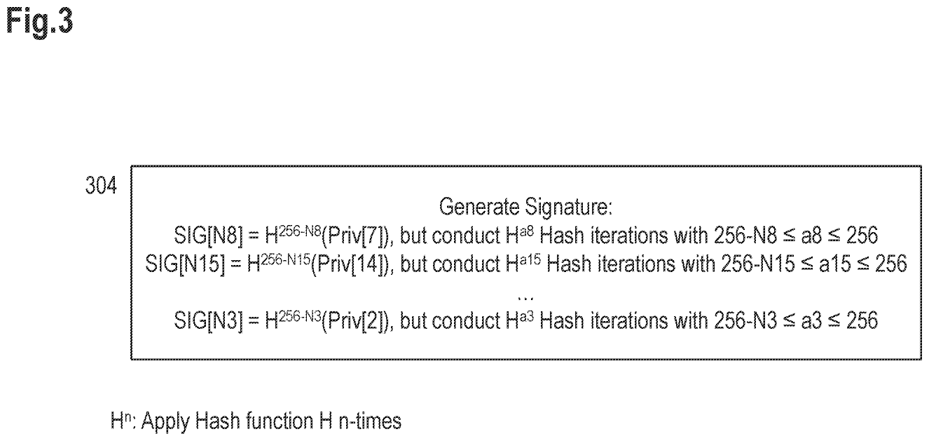

FIG. 3 shows an exemplary diagram comprising a step 304 which may substitute step 104 in FIG. 1 or step 204 in FIG. 2. Contrary to FIG. 2 the signature is not generated in the order
SIG[N1], SIG[N2], . . . , SIG[N32]
   but in an (exemplary) arbitrary order
SIG[N8], SIG[N15], . . . , SIG[N3].

It is noted that this (e.g., arbitrary) order also comprises all values SIG[N1] to SIG[N32], but the order of processing within step 304 is different from step 204. However, at the end of step 304, the full signature SIG[N1], . . . , SIG[N32] is compiled and ready for further processing.

This bears the advantage, that the WOTS chains are further protected against side-channel attacks, because for an attacker it is not apparent which WOTS chain the actual processing of Hash functions is associated with.

### Optional: Protect Checksum Chains

It is another option to protect at least one checksum chain, in particular all checksum chains.

It is noted that some of the WOTS chains are subject to checksum information. Such checksum can be appended to the transformed message as defined in, e.g., RFC 8391.

The protection described herein may be applied to at least one WOTS chain that is at least partially subject to a checksum information.

If an exemplary implementation comprises three WOTS chains that are used for checksum information, one, two or all three WOTS checksum chains can be protected according to any of the side-channel protection mechanisms as described herein. It is in particular an option to only protect at least one WOTS checksum chain.

### Further Embodiments and Examples

It is also an option to additionally protect function calls that involve generating the huge amount of one-time secret keys from the secret key SEED. This can be done by using known approaches to reduce the risk of successful side-channel attacks.

The solutions presented herein allow hardening the cryptographic system against side-channel attacks with only a minor (and adjustable) performance overhead.

Another advantage is that the solution is compatible with existing signature verification.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and dise, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

What is claimed is:

1. A method for generating a Hash-based signature based on a Winternitz one-time signature scheme, wherein the signature comprises several signature values that are determined via Hash-functions that are iteratively applied depending on a message and/or checksum, comprising the step:
generating the signature values at least partially in a mixed order, which is determined based on at least one of the following:
a predefined or deterministic pattern,
a pseudo-random pattern,
a random pattern.

2. The method according to claim 1, wherein the method comprises temporarily storing the mixed order in order to restore the order of the signature values before they are further processed.

3. The method of claim 1, wherein the method comprises, for at least one of the signature values, applying the Hash function at least one more time than necessary according to the Winternitz one-time signature scheme.

4. The method of claim 3, wherein the method comprises, for at least one signature value, iterating the Hash function as many times as necessary to reach the corresponding public key value.

5. The method of claim 3, wherein the method comprises, for at least one of the signature values, applying the Hash function an additional number ai times, wherein ai is larger than the number of times required to determine the signature value according to the Winternitz one-time signature scheme and smaller than or equal to the number of times necessary to reach the public key value, wherein ai is determined based on at least one of the following:
a deterministic scheme,
a predefined scheme,
a pseudo-random scheme,
a random scheme.

6. The method of claim 5, wherein different numbers ai are used for different signature values.

7. The method according of claim 1, further comprising:
for at least one of the signature values, applying the Hash function at least one more time than required according to the Winternitz one-time signature scheme, wherein the signature value is based on the checksum.

8. The method of claim 1, wherein a generator function that determines one-time keys based on a secret SEED, wherein such one-time keys are the basis for iteratively applying the Hash function, is protected from side-channel attacks.

9. The method of claim 8, wherein method comprises processing the one-time keys at least partially in a mixed order, which is determined based on at least one of the following:
a predefined or deterministic pattern,
a pseudo-random pattern,
a random pattern.

10. The method of claim 8, wherein the Hash function is a cryptographically hardened Hash function.

11. A device for generating a Hash-based signature based on a Winternitz one-time signature scheme, wherein the signature comprises several signature values (SIG[N1], . . . , SIG[N32]), which are determined via Hash-functions that are iteratively applied depending on a message and/or checksum, wherein the device is arranged to:
generate the signature values at least partially in a mixed order, which is determined based on at least one of the following:
a predefined or deterministic pattern,
a pseudo-random pattern,
a random pattern.

12. The device according to claim 11, wherein the device is a cryptographic device or a device that is arranged to conduct at least one cryptographic function, in particular to generate the Hash-based signature.

13. The device according to claim 11, wherein said device is a security device comprising at least one of the following:
an integrated circuit,
a hardware security module,
a trusted platform module,
a crypto unit,
a FPGA,
a processing unit,
a controller,
a smartcard.

14. A non-transitory computer-readable medium comprising, stored thereupon, a computer program product directly loadable into a memory of a digital processing device, the computer program product comprising software code portions for performing the steps of the method of claim 1.
